(19) United States
(12) Patent Application Publication
(10) Pub. No.: US 2009/0051127 A1
(43) Pub. Date: Feb. 26, 2009

(54) Water-proof mechanism for a container or device

(75) Inventor: TONY CHUNLUNG YOUNG, Hong Kong (HK)

Correspondence Address: Eric Chan, 42 Pin Oaks Drive, Phoenixville, PA, 19460, US

(73) Assignee: CALTRACO INTERNATIONAL LIMITED

(21) Appl. No.: 11/845,039

(22) Filed: Aug. 25, 2007

(51) Int. Cl. F16J 15/10

(52) U.S. Cl. 277/639

(57) ABSTRACT

A water-proof mechanism for a container or device which comprises a casing with an opening having a threaded portion disposed on the outer or inner surface of the casing at or near the opening; a first removable or linked cover with a corresponding threaded portion disposed on its inner or outer surface for engaging with the threaded portion of the casing with a cavity formed in between the first cover and the opening; and a second removable or linked cover disposed inside the cavity for closing the opening with one or more sealing members in between to seal at the interface. The container or device with the present mechanism can be immediately and easily unsealed for next use, and the water-proof function is more reliable and the construction is less complicated with less time and costs or production.

### BACKGROUND OF THE INVENTION

The present invention relates to a water-proof mechanism and more particularly pertains to a water-proof mechanism for sealing a submersible container or device.

Different kinds of water-proof mechanisms are available in the marketplace. Different containers or devices that are designed for submerging and operating under water adapt different water-proof mechanisms to ensure their capability of functioning while submersed. Among various water-proof mechanisms, it is common to place a gasket of rubber or plastic around a joint formed by two parts of a container or device, and when the two parts are fixed together, the gasket is compressed and fills the space in between and thus creates a seal at the interface, thereby making the joint watertight.

Typically, a container or device has an opening with a threaded portion, a separated cover with a corresponding threaded portion which can engage with the threaded portion of the opening, and one or more gaskets placed in a groove or grooves formed by the threads or at the lid of the opening or the cover where the opening contacts with the cover. The opening can therefore be sealed by the cover through engaging the respective threaded portions, and the gasket or the gaskets are compressed in between and tightly fill the surrounding space making the sealing watertight.

For instance, this mechanism is commonly applied in a submersible lantern or torch, which has a casing with an opening for inserting batteries therein and a detachable end cap for removably closing the opening. A conventional submersible lantern or torch is disposed with one or more o-rings made of elastomer which are placed in between the opening and the end cap to make it watertight when the end cap is screwed to or otherwise engaged with the opening.

Expansive elements such as elastomeric foam blocks or spring-load devices are used in some submersible containers or devices, wherein one or more expansive parts are disposed in a compressed state to support an elastomeric faceplate or sealing plate so that the pressure created by the expansive part or parts is directed to the plate to produce the sealing effect. This mechanism can be employed to increase or prolong the water-proof capability of the submersible containers or devices.

However, irrespective of the complexity of the existing water-proof mechanisms, there remains a problem to be overcome. When the containers or devices with these mechanisms are submerged in water for a period, as the pressure in deep water is higher than the pressure inside the containers or devices, the covers or caps of the containers or devices are usually compressed against the openings. Owing to the high water pressure, air trapped in the gaps between the sealants such as gaskets, o-rings or expansive elements and the covers or caps or the openings will escape. The gaps are therefore in a vacuum condition. The containers or devices are thus tightly sealed, and even when the containers or devices are taken out from water, the gaps maintain to be a vacuum. Since the friction between the sealants and the covers or caps or the openings is great, the covers or caps can hardly be unscrewed or otherwise disengaged with the openings.

Generally, it takes time for air to run into the gaps, and the covers or caps cannot be unscrewed or separated from the openings until the vacuum condition disappears. If the vacuum condition fails to disappear, the containers or devices with these mechanisms will become useless. One has to break the containers to take out the things inside but the containers will be broken and become useless. As for electric devices with these mechanisms, when the batteries run out and cannot be replaced, the devices will also become useless.

### BRIEF SUMMARY OF THE INVENTION

In view of the aforesaid disadvantages now present in the prior art, the object of the present invention is to provide a water-proof mechanism for a container or device which can tightly seal its opening preventing water from leaking in when it is submerged in water and can allow its cover or lid to be easily and immediately removed from its opening when it is taken out of the water.

To attain this, the present invention generally comprises a casing with an opening having a threaded portion disposed on the outer or inner surface of the casing at or near the opening; a first removable or linked cover with a corresponding threaded portion disposed on its inner or outer surface for engaging with the threaded portion of the casing with a cavity formed in between the first cover and the opening; and a second removable or linked cover disposed inside the cavity for closing the opening with one or more sealing members in between to seal at the interface.

The sealing member can be a gasket or o-ring.

The sealing member is made of rubber, plastic, elastomeric or other soft material.

The opening can have one or more sealing members which are disposed on the outer or inner surface of the casing in contact with the second cover. Or, alternatively, the second cover can have one or more sealing members on its surface in contact with the opening. As a further alternative, both the opening and the second cover can have one or more sealing members.

The opening has one or more grooves for holding one or more sealing members. The second cover has one or more grooves for holding one or more sealing members.

The opening can be in any shape but preferably in circular shape. The shape of the second cover corresponds to the shape of the opening.

The opening can be in the shape of a narrowed mouth and the shape of the second cover corresponds to the shape of the narrowed mouth.

The opening can be in the shape of a receding mouth and the shape of the second cover corresponds to the shape of the receding mouth.

The cross section of the threaded portion of the casing is in circular shape and the shape of the threaded portion of the first cover corresponds to the circular shape of the threaded portion of the casing.

The first cover can be a linked cover by means of a chain or hinge. The second cover can also be a linked cover by means of a chain or hinge.

The first cover can be an open end cover in the form of a bezel or a nut.

To use the present invention, when sealing a container or device to make it water-proof, the user can close the opening with the second cover. The sealing members in between the second cover and the opening therefore fill the surrounding space tightly making a seal at the interface. The user can then screw the first cover to the casing by engaging the threaded portion of the first cover with that of the casing. The opening is thus closed by the first cover as well.

When the sealed container or device is submerged and operated under water, as there are no sealing members disposed between the threaded portions, a certain quantity of water may leak into the cavity, but since the cavity has air inside, the leaking ceases with air trapped in the cavity, and so the air trapped in the gaps between the sealing members and the second cover and/or the opening does not escape. The container or device is therefore made water-tight.

When the container or device is taken out from water, since there are no sealing members disposed between the threaded portions, the friction to unscrew the first cover from the casing is small, and so the first cover can be easily unscrewed. As the air trapped in the gaps between the sealing members and the second cover and/or the opening does not escape, the air serves as a lubricant to reduce the friction and the removal of the second cover from the opening therefore becomes effortless. The user can easily open the container to take out the things inside or open the device to take out the old batteries and replace them with the new ones.

In comparison with the prior art, the present invention has the following advantages and effects:

Firstly, since the sealing members are not disposed on the threaded portions but in between the second cover and the casing, unsealing of the container or device becomes effortless. The problem of difficult unscrewing of the cover from the opening in the conventional mechanisms can be solved. In comparison with the conventional mechanisms, the container or device with the present invention can be immediately and easily unsealed for next use.

Secondly, as the present invention preserves the use of the traditional sealing members such as gaskets or o-rings instead of expansive materials such as springs to seal the container or device, the water-proof function is more reliable and the construction is less complicated with less time and costs or production.

Further objects, features, and advantages of the invention will become more apparent from the following description and the appended claims with reference to the accompanying drawings, all of which form a part of this specification.

### BRIEF DESCRIPTION OF THE DRAWINGS

FIG. 1 shows the cross-sectional view of the first embodiment of the present invention.

FIG. 2 shows the exploded cross-sectional view of the first embodiment.

FIG. 3 shows the perspective view of the first embodiment.

FIG. 4 shows the exploded perspective view of the first embodiment.

FIG. 5 shows the cross-sectional view of the second embodiment of the present invention.

FIG. 6 shows the exploded cross-sectional view of the second embodiment.

FIG. 7 shows the cross-sectional view of the third embodiment of the present invention.

FIG. 8 shows the exploded cross-sectional view of the third embodiment.

FIG. 9 shows the cross-sectional view of the fourth embodiment of the present invention.

FIG. 10 shows the exploded cross-sectional view of the fourth embodiment.

FIG. 11 shows the cross-sectional view of the fifth embodiment of the present invention.

FIG. 12 shows the exploded cross-sectional view of the fifth embodiment.

### DETAILED DESCRIPTION OF THE INVENTION

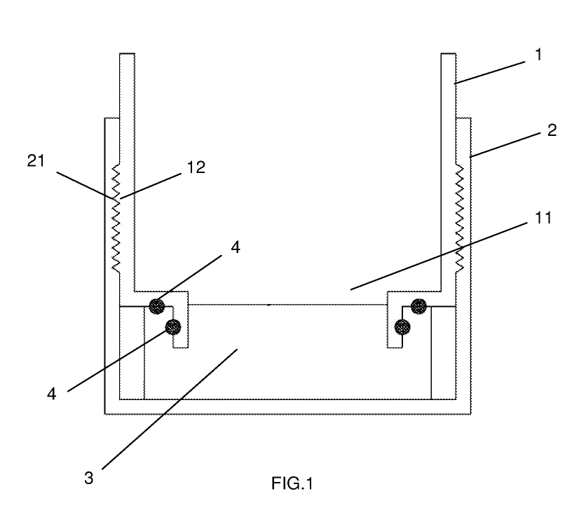

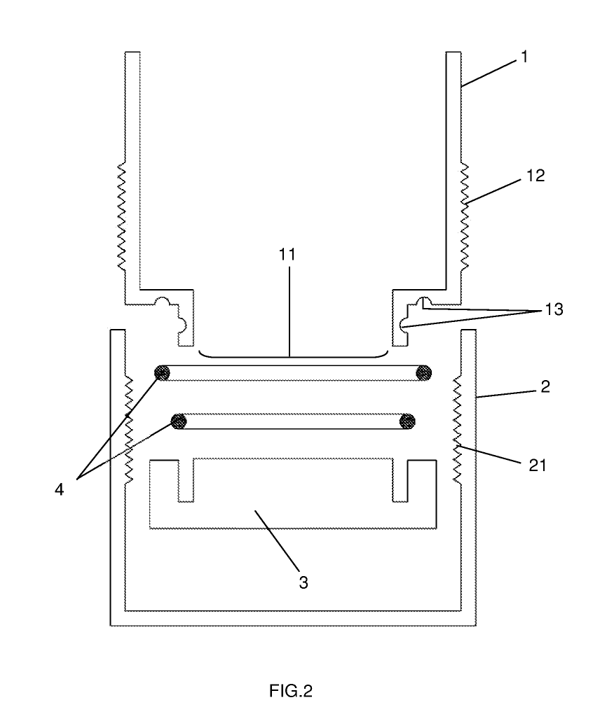

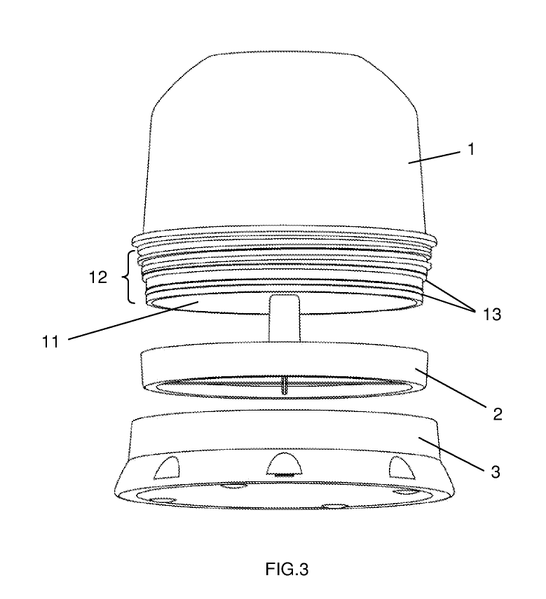

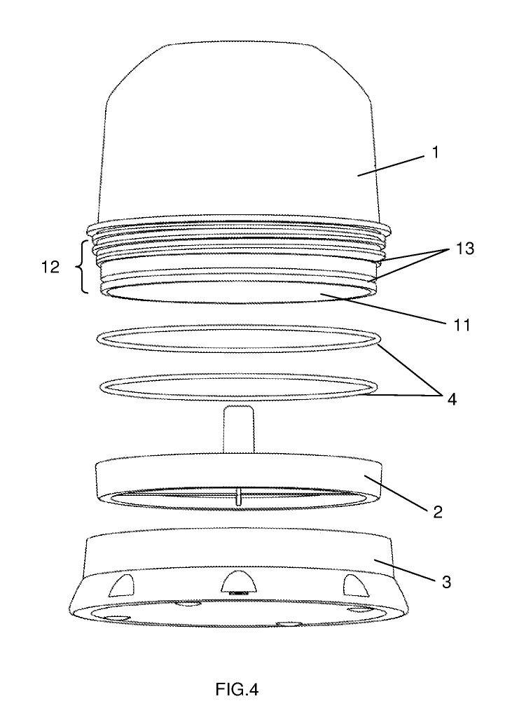

The preferred embodiments of the present invention are further described in detail with the following embodiment and the accompanying drawings. FIGS. 1 to 4 show the first embodiment of the present invention. As shown in FIGS. 3 and 4, the first embodiment is a water-proof mechanism for a submersible lantern which is powered by batteries. As shown in FIGS. 1 and 2, the water-proof mechanism comprises a casing 1 with an opening 11 in circular shape and in the shape of a narrowed mouth having a threaded portion 12 disposed on the outer surface of the casing 1 near the opening 11; a first removable cover 2 with a corresponding threaded portion 21 disposed on its inner surface for engaging with the threaded portion 12 of the casing 1 with a cavity formed in between the first cover 2 and the opening 11; and a second removable cover 3 disposed inside the cavity for closing the opening 11 with two sealing members 4 in between to seal at the interface. The sealing members 4 are disposed inside the grooves 13 on the opening 11.

In the first embodiment, the sealing members 4 are two o-rings made of elastomeric material and in other embodiments the sealing members 31 can be gaskets and can be made of rubber, plastic, soft or other elastomeric material. In this embodiment, two sealing members 4 are disposed on the outer surface of the casing 1 in contact with the second cover 3. In other embodiments, there can be one or more sealing members 4 disposed on the surface of the second cover 3 in contact with the opening 11 or on the surfaces of both the second cover 3 and the outer or inner surface of the casing 1.

The cross section of the threaded portion 12 of the casing 1 is in circular shape and the shape of the threaded portion 21 of the first cover 2 corresponds to the circular shape of the threaded portion 12 of the casing 1. The first cover 2 and the second cover 3 are removable covers in this embodiment and each of them can be a linked cover by means of a chain or hinge in other embodiments.

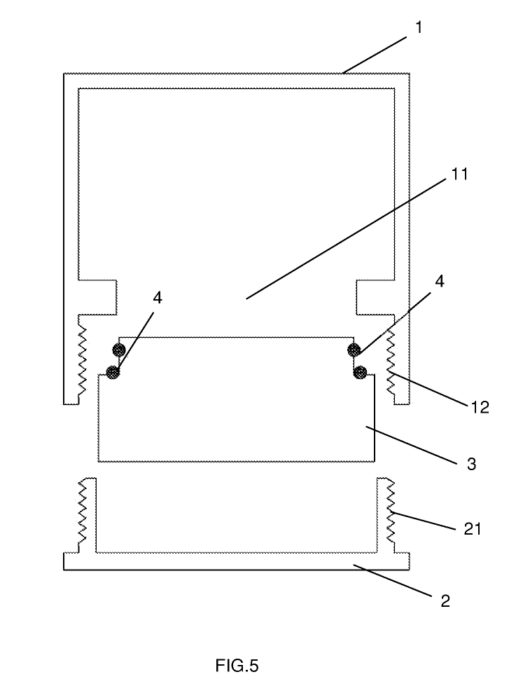

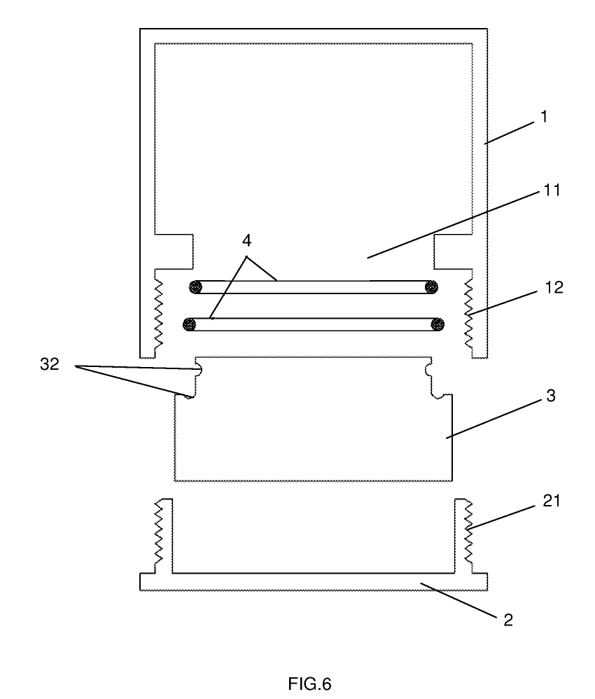

FIGS. 5 to 6 show the second embodiment of the present invention. The water-proof mechanism of this embodiment is similar to that of the first embodiment, save that as shown in FIGS. 5 and 6, the opening 11 of the casing 1 is in the shape of a receding mouth having the threaded portion 12 disposed on the inner surface of the casing 1 at the opening 11, and the threaded portion 21 of the first cover 2 is disposed on its outer surface, and the two sealing members 4 are disposed inside the grooves 32 on the second cover 3.

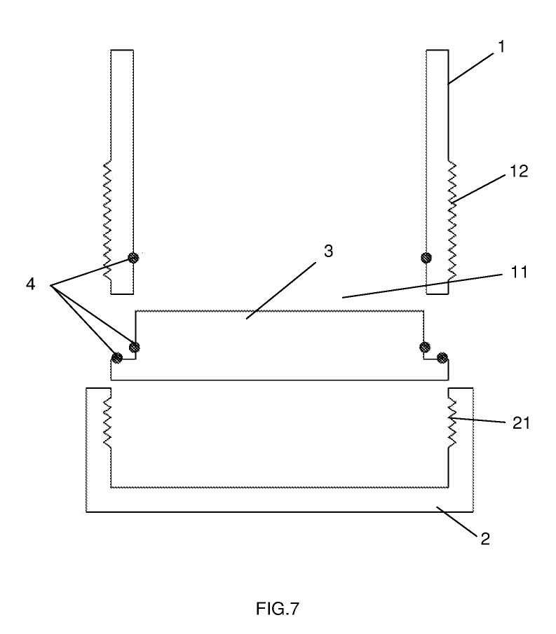

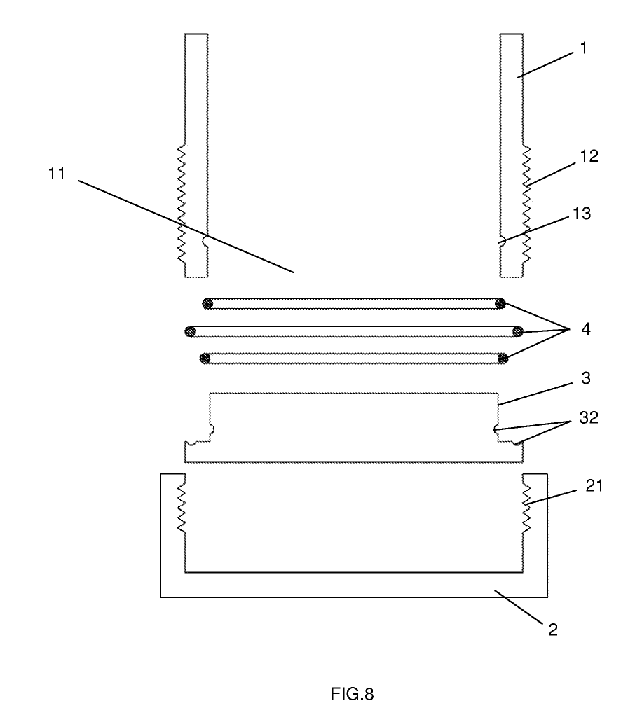

FIGS. 7 to 8 show the third embodiment of the present invention. The water-proof mechanism of this embodiment is similar to that of the second embodiment, save that as shown in FIGS. 7 and 8, the opening 11 of the casing 1 is in circular shape without a receding or narrowed mouth, and the two sealing members 4 are disposed inside the grooves 32 on the second cover 3 with one additional sealing member 4 is disposed inside the groove 13 on the opening 11.

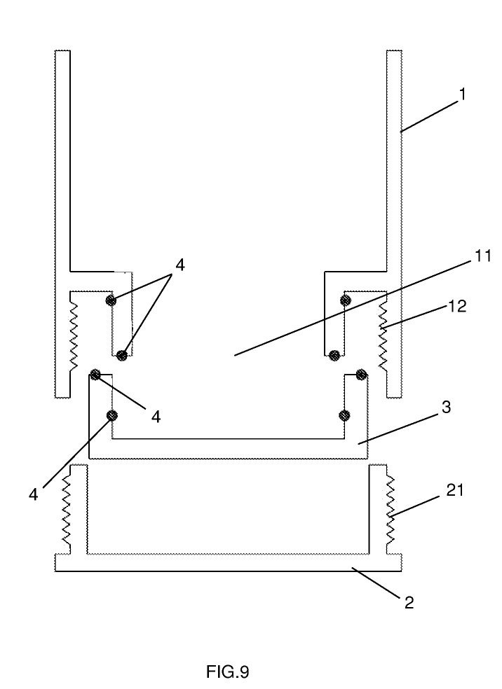

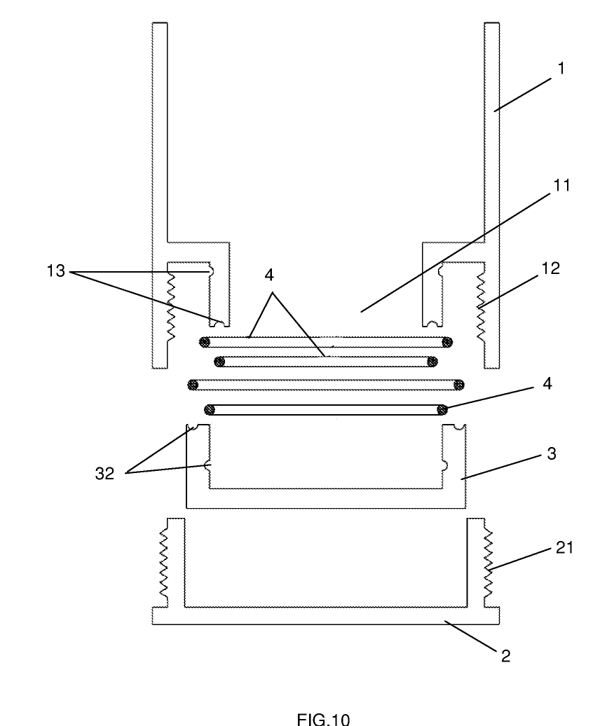

FIGS. 9 to 10 show the fourth embodiment of the present invention. The water-proof mechanism of this embodiment is similar to that of the second embodiment, save that as shown in FIGS. 9 and 10, the opening 11 of the casing 1 is in the shape of a receding mouth with a smaller narrowed mouth inside the receding mouth, and the two sealing members 4 are disposed inside the grooves 32 on the second cover 3 with two additional sealing member 4 are disposed inside the grooves 13 on the opening 11.

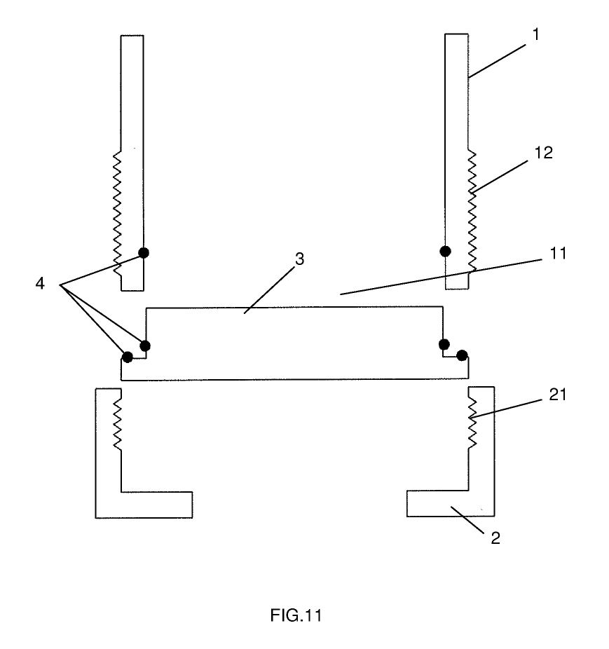

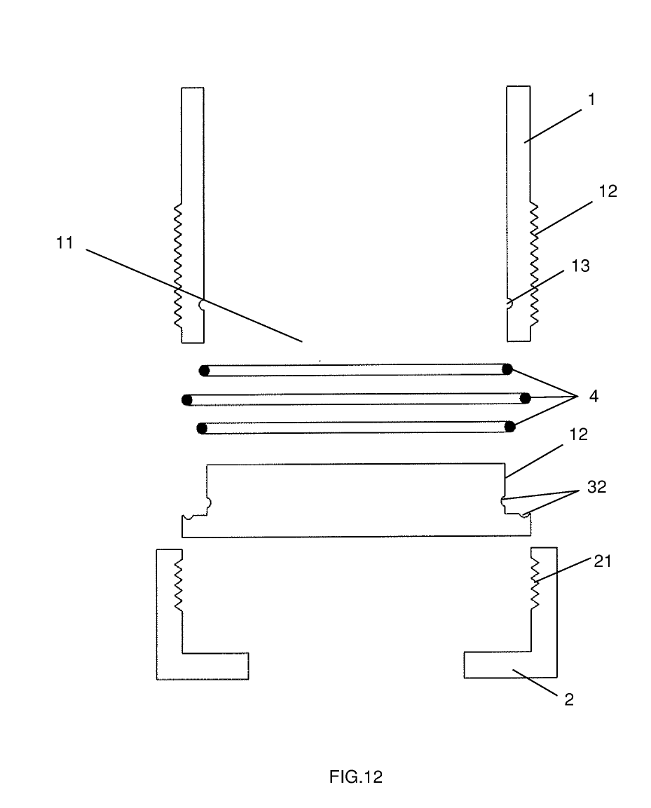

FIGS. 11 to 12 show the fifth embodiment of the present invention. The water-proof mechanism of this embodiment is similar to that of the third embodiment, save that as shown in FIGS. 11 and 12, the first cover 2 is an open end cover which takes the form of a nut.

The above embodiments are preferred embodiments of the present invention. The present invention is capable of other embodiments and is not limited by the above embodiments. Any other variation, decoration, substitution, combination or simplification, whether in substance or in principle, not deviated from the spirit of the present invention, is replacement or substitution of equivalent effect and falls within the scope of protection of the present invention.

What is claimed is:

1. A water-proof mechanism for a container or device comprising a casing with an opening having a threaded portion disposed on the outer or inner surface of the casing at or near the opening; a first removable or linked cover with a corresponding threaded portion disposed on its inner or outer surface for engaging with the threaded portion of the casing with a cavity formed in between the first cover and the opening; and a second removable or linked cover disposed inside the cavity for closing the opening with one or more sealing members in between to seal at the interface.

2. The water-proof mechanism for a container or device as in claim 1, wherein the sealing member is a gasket or o-ring.

3. The water-proof mechanism for a container or device as in claim 1, wherein the sealing member is made of rubber, plastic or elastomeric material.

4. The water-proof mechanism for a container or device as in claim 1, wherein the opening has one or more sealing members which are disposed on the outer or inner surface of the casing in contact with the second cover

5. The water-proof mechanism for a container or device as in claim 1, wherein the second cover has one or more sealing members on its surface in contact with the opening.

6. The water-proof mechanism for a container or device as in claim 1, wherein both the opening and the second cover have one or more sealing members.

7. The water-proof mechanism for a container or device as in claim 1, wherein the opening has one or more grooves for holding one or more sealing members.

8. The water-proof mechanism for a container or device as in claim 1, wherein the second cover has one or more grooves for holding one or more sealing members.

9. The water-proof mechanism for a container or device as in claim 1, wherein the opening is in circular shape.

10. The water-proof mechanism for a container or device as in claim 1, wherein the shape of the second cover corresponds to the shape of the opening.

11. The water-proof mechanism for a container or device as in claim 1, wherein the opening is in the shape of a narrowed mouth and the shape of the second cover corresponds to the shape of the narrowed mouth.

12. The water-proof mechanism for a container or device as in claim 1, wherein the opening is in the shape of a receding mouth and the shape of the second cover corresponds to the shape of the receding mouth.

13. The water-proof mechanism for a container or device as in claim 1, wherein the cross section of the threaded portion of the casing is in circular shape and the shape of the threaded portion of the first cover corresponds to the circular shape of the threaded portion of the casing.

14. The water-proof mechanism for a container or device as in claim 1, wherein the first cover is a linked cover by means of a chain or hinge.

15. The water-proof mechanism for a container or device as in claim 1, wherein the second cover is a linked cover by means of a chain or hinge.

16. The water-proof mechanism for a container or device as in claim 1, wherein the first cover is an open end cover in the form of a bezel or a nut.
